(19) United States
(12) Patent Application Publication
(10) Pub. No.: US 2015/0049692 A1
(43) Pub. Date: Feb. 19, 2015

(54) CHANNEL STATE INFORMATION FEEDBACK METHOD AND USER EQUIPMENT

(71) Applicant: Sharp Kabushiki Kaisha, Osaka-shi, Osaka (JP)

(72) Inventors: Ming Ding, Shanghai (CN); Lei Huang, Shanghai (CN); Renmao Liu, Shanghai (CN)

(73) Assignee: Sharp Kabushiki Kaisha, Osaka-shi, Osaka (JP)

(21) Appl. No.: 14/382,788

(22) PCT Filed: Mar. 12, 2013
(86) PCT No.: PCT/JP2013/001622

§ 371 Date: Sep. 4, 2014

(30) Foreign Application Priority Data
Mar. 13, 2012 (CN) 201210064251.7

(51) Int. Cl. H04L 5/00; H04B 7/06

(52) U.S. Cl. CPC H04L 5/0057; H04B 7/0626; H04B 7/0632
USPC 370/329

(57) ABSTRACT

A Channel State Information (CSI) feedback method and a user equipment (UE) are provided. The CSI feedback method comprises: selecting a communication resource by which non-coherent Joint Transmission (JT) is performed, wherein the non-coherent JT achieves a performance target by using the selected communication resource; and feeding back, to a Base Station (BS) participating in the non-coherent JT, an indication of the selected communication resource as enhanced CSI.

### TECHNICAL FIELD

The present invention relates to communication technology, and more particularly, to a method for feeding back Channel State Information (CSI) in a multi-Base station (multi-BS) coordination mode and a user equipment corresponding thereto.

### BACKGROUND ART

Multiple Input Multiple Output (MIMO) wireless transmission technique can achieve spatial multiplex gain and spatial diversity gain by deploying a plurality of antennas at both the transmitter and the receiver and utilizing the spatial resources in wireless transmission. Researches on information theory have shown that the capacity of a MIMO system grows linearly with the minimum of the number of transmitting antennas and the number of receiving antennas. FIG. 1 shows a schematic diagram of a MIMO system. As shown in FIG. 1, a plurality of antennas at the transmitter and a plurality of antennas at each of the receivers constitute a multi-antenna wireless channel containing spatial domain information. Further, Orthogonal Frequency Division Multiplexing (OFDM) technique has a strong anti-fading capability and high frequency utilization and is thus suitable for high speed data transmission in a multi-path and fading environment. The MIMO-OFDM technique, in which MIMO and OFDM are combined, has become a core technique for a new generation of mobile communication.

For instance, the 3^{rd} Generation Partnership Project (3GPP) organization is an international organization in mobile communication field and plays an important role in standardization of 3G cellular communication technologies. Since the second half of the year 2004, the 3GPP organization has initiated a so-called Long Term Evolution (LTE) project for designing Evolved UMTS Terrestrial Radio Access (EUTRA) and Evolved UMTS Terrestrial Radio Access Network (EUTRAN). The MIMO-OFDM technique is employed in the downlink of the LTE system. In a conference held in Shenzhen, China in April 2008, the 3GPP organization started a discussion on the standardization of 4G cellular communication systems (currently referred to as LTE-A systems). In this conference, a concept known as “multi-antenna multi-BS coordination” gets extensive attention and support. Its core idea is that multiple BSs can provide communication services for one or more user equipments (UEs) simultaneously, so as to improve data transmission rate for a UE located at the edge of a cell.

With regard to the multi-antenna multi-BS coordination, fundamental agreements are mainly available from the following Non Patent Literature 1 (standard document) by March, 2010: 3GPP TR 36.814 V9.0.0 (2010 March), “Further advancements for E-UTRA physical layer aspects (Release 9)”, which can be outlined as follows:

(1) In a multi-antenna multi-BS service, a UE needs to report channel state/statistical information of a link between the UE and each BS/cell in a set of cells. This set of cells is referred to as a measurement set for multi-antenna multi-BS transmission.

(2) The set of BSs/cells for which the UE actually performs information feedback can be a subset of the measurement set and is referred to as a coordination set for multi-antenna multi-BS transmission. Obviously, the coordination set for multi-antenna multi-BS transmission can be the same as the measurement set for multi-antenna multi-BS transmission.

(3) A BS/cell in the coordination set for multi-antenna multi-BS transmission participates in Physical Downlink Shared Channel (PDSCH) transmission for the UE, either directly or indirectly. The Physical Downlink Shared Channel is the data channel of the UE.

(4) The scheme in which multiple BSs directly participate in coordination transmission is referred to as Joint Processing (JP). The JP scheme needs to share PDSCH signal of the UE among the multiple BSs participating the coordination and can be divided into two approaches. One is referred to as Joint Transmission (JT) in which the multiple BSs transmit their PDSCH signals to the UE simultaneously. The other one is referred to as Dynamic Cell Selection (DCS) in which at any time only one of the BSs which has the optimum signal link is selected to transmit its PDSCH signal to the UE. It should be noted that, with the advance of the standardization process, the DCS shall be understood in an extended sense of “Transmission Point” (TP), rather than in a limited sense of “cell”. The term transmission point refers to a set of a plurality of transmission ports corresponding to a downlink Reference Signal pattern (CSI-RS Pattern).

(5) The scheme in which multiple BSs indirectly participate in coordination transmission is referred to as Coordinated Beamforming/Coordinated Scheduling (CB/CS). In this CB/CS scheme, instead of sharing PDSCH signal of the UE among the multiple BSs participating in the coordination, the beams/resources for transmission of PDSCHs for different UEs are coordinated among the multiple BSs to suppress the interference between each other.

(6) For a UE operating in the multi-antenna multi-BS coordinated transmission environment, information feedback is mainly carried out separately for each BS and is transmitted over the uplink resources of the serving BS.

As used herein, the term “information feedback” mainly refers to a process in which a UE feeds back CSI to a BS such that the BS can perform corresponding operations such as radio resource management. There are primarily the following three CSI feedback approaches in the prior art.

(Complete CSI Feedback): The UE quantizes all elements in a transceiver channel matrix and feeds back each of the elements to the BS. Alternatively, the UE can analogously modulate all elements in the transceiver channel matrix and feeds back them to the BS. Alternatively, the UE can obtain a transient covariance matrix for the transceiver channel matrix, quantizes all elements in the covariance matrix and feeds back each of the elements to the BS. Thus, the BS can reconstruct an accurate channel from the channel quantization information fed back from the UE. This approach is described in detail in Non Patent Literature 2: 3GPP R1-093720, “CoMP email summary”, Qualcomm and its implementation is illustrated in FIG. 2.

(Statistic-Based CSI Feedback): The UE applies a statistical process on a transceiver channel matrix, e.g., calculating a covariance matrix thereof, quantizes the statistical information and then feeds back it to the BS. Thus, the BS can obtain statistical state information of the channel based on the feedback from the UE. This approach is described in detail in Non Patent Literature 2: 3GPP R1-093720, “CoMP email summary”, Qualcomm and its implementation is illustrated in FIG. 3.

(CSI Feedback Based on Codebook Space Search): A finite set of CSI is predefined by the UE and the BS (i.e., codebook space, common codebook spaces including channel rank and/or precoding matrix and/or channel quality indication, etc.). Upon detection of a transceiver channel matrix, the UE searches in the codebook space for an element best matching the CSI of the current channel matrix and feeds back the index of the element to the BS. Thus, the BS looks up the predefined codebook space based on the index to obtain rough CSI. This approach is described in detail in Non Patent Literature 3: 3GPP, R1-083546, “Per-cell precoding methods for downlink joint processing CoMP”, ETRI, and its implementation is illustrated in FIG. 4.

Among the above three approaches, the complete CSI feedback has the best performance, but is impractical to be applied to actual system due to the highest feedback overhead. In particular, in the multi-antenna multi-BS coordination system, its feedback overhead grows in proportional to the increase of the number of BSs and it is even more impractical. The CSI feedback based on codebook space search has the lowest feedback overhead, but is worst in terms of performance since it cannot accurately describe the channel state such that the transmitter cannot make full use of channel characteristics and cannot perform transmission accordingly. However, it is extremely simple to implement and can typically accomplish feedback with a few bits. Hence, it is widely applied in actual systems. In comparison, the statistic-based CSI feedback achieves a good tradeoff between these two approaches. When the channel state has significant statistical information, this approach can accurately describe the channel state with a relatively small amount of feedback, thereby achieving a relatively ideal performance.

Currently, in the LTE and the LTE-A systems, in consideration of factors for practical system implementation, the CSI feedback based on codebook space search is employed in a single cell transmission mode. In the multi-BS/cell coordination mode in the LTE-A system, it is expected that this CSI feedback based on codebook space search will continue to be used.

For the CSI feedback based on codebook space search, there are two feedback channels in the LTE system, namely, a Physical Uplink Control CHannel (PUCCH) and a Physical Uplink Shared CHannel (PUSCH). In general, the PUCCH is configured for transmission of periodic, basic CSI with low payload; while PUSCH is configured for transmission of bursty, extended CSI with high payload. For the PUCCH, a complete CSI is composed of various feedback contents which are transmitted in different sub-frames. For the PUSCH, on the other hand, a complete CSI is transmitted within one sub-frame. In the LTE-A system, such design remains applicable in principle.

The feedback contents can be divided into three categories: Channel Quality Index (CQI), Precoding Matrix Index (PMI) and Rank Index (RI), all of which are bit quantized feedbacks. The CQI typically corresponds to a transmission format having a packet error rate no more than 0.1.

In the LTE system, the following eight types of MIMO transmission approaches for downlink data are defined:

(1) Single antenna transmission. This is used for signal transmission at a single-antenna BS. This approach is a special instance of MIMO system and can only transmit a single layer of data.

(2) Transmission diversity. In a MIMO system, diversity effects of time and/or frequency can be utilized to transmit signals, so as to improve the reception quality of the signals. This approach can only transmit a single layer of data.

(3) Open-loop space division multiplexing. This is a space division multiplexing without the need for PMI feedback from UE.

(4) Closed-loop space division multiplexing. This is a space division multiplexing in which PMI feedback from UE is required.

(5) Multi-user MIMO. There are multiple UEs simultaneously participating in the downlink communication of the MIMO system on the same frequency.

(6) Closed-loop single layer precoding. Only one single layer of data is transmitted using the MIMO system. The PMI feedback from UE is required.

(7) Beam forming transmission. The beam forming technique is employed in the MIMO system. A dedicated reference signal is used for data demodulation at UE. Only one single layer of data is transmitted using the MIMO system. The PMI feedback from UE is not required.

(8) Two-layer beam forming transmission. The UE can be configured to feed back PMI and RI, or not to feed back PMI and RI. In the LTE-A system, the above eight types of transmission approaches may be retained and/or cancelled.

Optionally, a new type of transmission approach, type 9) dynamic MIMO switching, can be added. In this type of transmission approach, the BS can dynamically adjust the MIMO mode in which the UE operates.

In order to support the above MIMO transmission approaches, a variety of CSI feedback modes are defined in the LTE system. Each MIMO transmission approach corresponds to a number of CSI feedback modes, as detailed in the following.

There are four CSI feedback modes for the PUCCH, namely, Mode 1-0, Mode 1-1, Mode 2-0 and Mode 2-1. These modes are combination of four types of feedbacks, including:

(1) Type 1: one preferred sub-band location in a Band Part (BP, which is a subset of the set of communication spectrum resources S and has a size dependent on the size of the Set S) and a CQI for the sub-band. The respective overheads are L bits for the sub-band location, 4 bits for the CQI of the first codeword and 3 bits for the CQI of the possible second codeword which is differentially coded with respect to the CQI of the first codeword.

(2) Type 2: wideband CQI and PMI. The respective overheads are 4 bits for the CQI of the first codeword, 3 bits for the CQI of the possible second codeword which is differentially coded with respect to the CQI of the first codeword and 1, 2 or 4 bits for PMI depending on the antenna configuration at BS.

(3) Type 3: RI. The overhead for RI is 1 bit for two antennas, or 2 bits for four antennas, depending on the antenna configuration at BS.

(4) Type 4: wideband CQI. The overhead is 4 bits.

The UE feeds back different information to the BS in correspondence with the above different types.

The Mode 1-0 is a combination of Type 3 and Type 4. That is, the feedbacks of Type 3 and Type 4 are carried out at different periods and/or with different sub-frame offsets, which means that the wideband CQI of the first codeword in the Set S and the RI information are fed back.

The Mode 1-1 is a combination of Type 3 and Type 2. That is, the feedbacks of Type 3 and Type 2 are carried out at different periods and/or with different sub-frame offsets, which means that the wideband PMI of the Set S, the wideband CQIs for the individual codewords and the RI information are fed back.

The Mode 2-0 is a combination of Type 3, Type 4 and Type 1. That is, the feedbacks of Type 3, Type 4 and Type 1 are carried out at different periods and/or with different sub-frame offsets, which means that the wideband CQI of the first codeword in the Set S, the RI information as well as one preferred sub-band location in the BP and the CQI for the first codeword on the sub-band are fed back.

The Mode 2-1 is a combination of Type 3, Type 2 and Type 1. That is, the feedbacks of Type 3, Type 2 and Type 1 are carried out at different periods and/or with different sub-frame offsets, which means that the wideband PMI of the Set S, the wideband CQIs for the individual codewords, the RI information, as well as one preferred sub-band location in the BP and the CQIs for the individual codewords on the sub-band are fed back.

There are thus the following correspondences between the MIMO transmission approaches and the CSI feedback modes:

MIMO transmission approach 1): Mode 1-0 and Mode 2-0;

MIMO transmission approach 2): Mode 1-0 and Mode 2-0;

MIMO transmission approach 3): Mode 1-0 and Mode 2-0;

MIMO transmission approach 4): Mode 1-1 and Mode 2-1;

MIMO transmission approach 5): Mode 1-1 and Mode 2-1;

MIMO transmission approach 6): Mode 1-1 and Mode 2-1;

MIMO transmission approach 7): Mode 1-0 and Mode 2-0;

MIMO transmission approach 8): Mode 1-1 and Mode 2-1, with PMI/RI feedback from UE; or Mode 1-0 and Mode 2-0, without PMI/RI feedback from UE.

Still, CQI, PMI and RI are primary feedback contents in the single BS transmission approach of the LTE-A system. In order to keep the feedback modes for a UE consistent with those corresponding to the transmission approaches 4) and 8) and to enable the new transmission approach 9), the Mode 1-1 and Mode 2-1 in the LTE-A system are optimized for a scenario where a BS is equipped with 8 transmission antennas. That is, a PMI is collectively determined from two channel precoding matrix indices W1 and W2, with W1 indicating wideband/long-term channel characteristics and W2 indicating sub-band/short-term channel characteristics. For transmission of W1 and W2 over PUCCH, Mode 1-1 is sub-divided into two sub-modes: Mode 1-1 (sub-mode 1) and Mode 1-1 (sub-mode 2). Also, the original Mode 2-1 is modified.

In order to support the newly defined feedback modes, several types of feedbacks are newly defined in the LTE-A system as follows:

Type 1a: one preferred sub-band location in a Band Part (BP, which is a subset of the set of communication spectrum resources S and has a size dependent on the size of the Set S) and a CQI for the sub-band, as well as a W2 for another sub-band. The overhead for the sub-band location is L bits, and the total overhead for the CQI and the W2 is 8 bits (if RI=1), 9 bits (if 1<RI<5), or 7 bits (if RI>4).

Type 2a: W1. The overhead for the W1 is 4 bits (if RI<3), 2 bits (if 2<RI<8), or 0 bits (if RI=8).

Type 2b: wideband W2 and wideband CQI. The total overhead for the wideband W2 and the wideband CQI is 8 bits (if RI=1), 11 bits (if 1<RI<4), 10 bits (if RI=4), or 7 bits (if RI>4).

Type 2c: wideband CQI, W1 and wideband W2. The total overhead for the wideband CQI, the W1 and the wideband W2 is 8 bits (if RI=1), 11 bits (if 1<RI<4), 9 bits (if RI=4), or 7 bits (if RI>4). It is to be noted that, in order to limit the feedback overhead, the W1 and the wideband W2 take values from an incomplete set (i.e., subset) of values, which is obtained by down-sampling all possible values of the W1 and the wideband W2.

Type 5: RI and W1. The total overhead for the RI and the WI is 4 bits (in the case of 8 antennae and 2-layer data multiplexing) or 5 bits (in the case of 8 antennae and 4/8-layer data multiplexing). Also, it is to be noted that, in order to limit the feedback overhead, the W1 takes values from an incomplete set (i.e., subset) of values, which is obtained by down-sampling all possible values of the W1.

Type 6: RI and Precoding Type Indicator (PTI). The overhead for PTI is 1 bit, indicating the type of precoding. The total overhead for the RI and the PTI is 2 bits (in the case of 8 antennae and 2-layer data multiplexing), 3 bits (in the case of 8 antennae and 3-layer data multiplexing), or 4 bits (in the case of 8 antennae and 8-layer data multiplexing).

In the description, “W2” when used alone refers to “sub-band W2”, while “wideband W2” is referred to by their full expressions.

The mode-type relationships between the Mode 1-1 (sub-mode 1), the Mode 1-1 (sub-mode 1) and the Mode 2-1 and the original and the above new types of feedbacks are as follows:

(1) the Mode 1-1 (sub-mode 1) is a combination of Type 5 and Type 2b. That is, the feedbacks of Type 5 and Type 2b are carried out at different periods and/or with different sub-frame offsets.

(2) the Mode 1-1 (sub-mode 2) is a combination of Type 3 and Type 2/2c,

(2.1) when the MIMO transmission approach is of type 4) or 8), the Mode 1-1 (sub-mode 2) is composed of Type 3 and Type 2. That is, the feedbacks of Type 3 and Type 2 are carried out at different periods and/or with different sub-frame offsets.

(2.2) when the MIMO transmission approach is of type 9), the Mode 1-1 (sub-mode 2) is composed of Type 3 and Type 2c. That is, the feedbacks of Type 3 and Type 2c are carried out at different periods and/or with different sub-frame offsets.

(3) the new Mode 2-1 is specific to the MIMO transmission approach of type 9), and is a combination of Type 6, Type 2b and Type 2a/1a,

(3.1) when the PTI of Type 6 is 0, the new Mode 2-1 is composed of Type 6, Type 2b and Type 2a. That is, the feedbacks of Type 6, Type 2b and Type 2a are carried out at different periods and/or with different sub-frame offsets.

(3.2) when the PTI of Type 6 is 1, the new Mode 2-1 is composed of Type 6, Type 2b and Type 1a. That is, the feedbacks of Type 6, Type 2b and Type 1a are carried out at different periods and/or with different sub-frame offsets.

Further, it is to be noted that the typical scenario for researching multi-antenna multi-BS coordination in the LTE-A system is where a macro BS is connected via optical fibers to a plurality of low-power Remote Radio Heads (RRHs) with cell IDs which are the same as or different from the BS′ cell ID, according to Non Patent Literature 4: The minutes of the 3GPP TSG-RAN WG1 meeting #63bis held in Dublin, Ireland in January 2011. The multi-antenna multi-BS coordination is significantly effective in improving the system throughput and CSI feedback for the multi-antenna multi-BS coordination becomes an important research topic, according to Non Patent Literature 5: The minutes of the 3GPP TSG-RAN WG1 meeting #66 held in Athens, Greek in August 2011.

Currently, as for the CSI feedback for multi-antenna multi-BS coordination in the LTE-A system, the preliminary conclusion is that the feedback contents involve CSI based on codebook space search, such as CQI, PMI and RI, and the information feedback is mainly based on independent feedback of CSI to each BS and is assisted with feedback of relative CSI (such as phase information) between BSs. Thus, schemes, such as JT, DPS, CS/CB, can be dynamically supported in a unified CSI feedback framework, according to Non Patent Literature 6: The minutes of the 3GPP TSG-RAN WG1 meeting #66bis held in Zhuhai, China in October 2011. In this framework, there are still a number of issues to be researched.

In particular, in the typical scenario for researching multi-antenna multi-BS coordination, the non-coherent JT which does not involve relative CSI between BSs achieves a certain increase in system performance at a relatively low feedback overhead (see Non Patent Literature 7: R1-120783, Ericsson, “Performance of Incoherent and Coherent JT CoMP” proposed at TSG-RAN WG1 meeting #68 held in February 2012).

### CITATION LIST

### Non Patent Literature

[NPL 1] 3GPP TR 36.814 V9.0.0 (2010-03), “Further advancements for E-UTRA physical layer aspects (Release 9)”.
[NPL 2] 3GPP R1-093720, “CoMP email summary”, Qualcomm.
[NPL 3] 3GPP, R1-083546, “Per-cell precoding methods for downlink joint processing CoMP”, ETRI.
[NPL 4] The minutes of the 3GPP TSG-RAN WG1 meeting #63bis held in Dublin, Ireland in January 2011.
[NPL 5] The minutes of the 3GPP TSG-RAN WG1 meeting #66 held in Athens, Greek in August 2011.
[NPL 6] The minutes of the 3GPP TSG-RAN WG1 meeting #66bis held in Zhuhai, China in October 2011.
[NPL 7] R1-120783, Ericsson, “Performance of Incoherent and Coherent JT CoMP” proposed at TSG-RAN WG1 meeting #68 held in February 2012.
[NPL 8] 3GPP, R1-092427, “CSI-RS Design for Virtualized LTE Antenna in LTE-A System”, Fujitsu.
[NPL 9] R1-114258, Ericsson, “CSI Feedback for DL CoMP” proposed at TSG-RAN WG1 meeting #67.

### SUMMARY OF INVENTION

### Technical Problem

However, feedback of existing CSI according to existing feedback modes does not support the non-coherent JT very well. Particularly, although the current technical specification specifies Mode 1-0 or Mode 2-0 as the typical feedback mode for the non-coherent JT, the feedback information associated with the existing Mode 1-0 or Mode 2-0 is less effective and the performance of the non-coherent JT is usually unsatisfactory.

In order to solve the above technical problems, the present invention proposes a novel CSI feedback method and user equipment, which improves the performance of the non-coherent JT by feeding back enhanced CSI. In order to be compatible with the existing specification, the present invention further propose how to feed back the enhanced CSI according to changed feedback modes.

### Solution to Problem

To achieve the above object, according to a first aspect of the present invention, a Channel State Information (CSI) feedback method is provided, which comprises: selecting a communication resource by which non-coherent Joint Transmission (JT) is performed, wherein the non-coherent JT achieves a performance target by using the selected communication resource; and feeding back, to a Base Station (BS) participating in the non-coherent JT, an indication of the selected communication resource as enhanced CSI.

To achieve the object of the present invention, according to a second aspect of the present invention, a User Equipment (UE) is provided, which comprises: a resource selection unit configured to select a communication resource by which non-coherent JT is performed, wherein the non-coherent JT achieves a performance target by using the selected communication resource; and a CSI feedback unit configured to feed back, to a BS participating in the non-coherent JT, an indication of the selected communication resource as enhanced CSI.

### Advantageous Effects of Invention

The CSI feedback method and user equipment according to the present invention have the advantages of high system throughput, simple implementation and low signaling overhead.

### BRIEF DESCRIPTION OF DRAWINGS

The above and other objects, features and advantages of the present invention will be more apparent from the following preferred embodiments illustrated with reference to the figures, in which:

FIG. 1 is a schematic diagram of a MIMO system;

FIG. 2 is a schematic diagram of complete CSI feedback;

FIG. 3 is a schematic diagram of statistic-based CSI feedback;

FIG. 4 is a schematic diagram of CSI feedback based on codebook space search;

FIG. 5 is a schematic diagram of a multi-cell cellular communication system;

FIG. 6 is a flowchart illustrating a CSI feedback method according to the present invention;

FIG. 7 is a schematic diagram illustrating a feedback type for feeding back a wideband CQI and enhanced CSI;

FIG. 8 is a schematic diagram illustrating a feedback type for feeding back the wideband CQI and an indication of selection of a BP;

FIG. 9 is a schematic diagram illustrating a feedback type for feeding back the wideband CQI and an indication of selection of a TP;

FIG. 10 is a schematic diagram illustrating a feedback type for feeding back the wideband CQI and an indication of selection of an AMC table;

FIG. 11 is a schematic diagram of a modulation and coding table obtained by shift;

FIG. 12 is a schematic diagram illustrating a feedback type for feeding back only the enhanced CSI; and

FIG. 13 is a schematic block diagram of a UE according to the present invention.

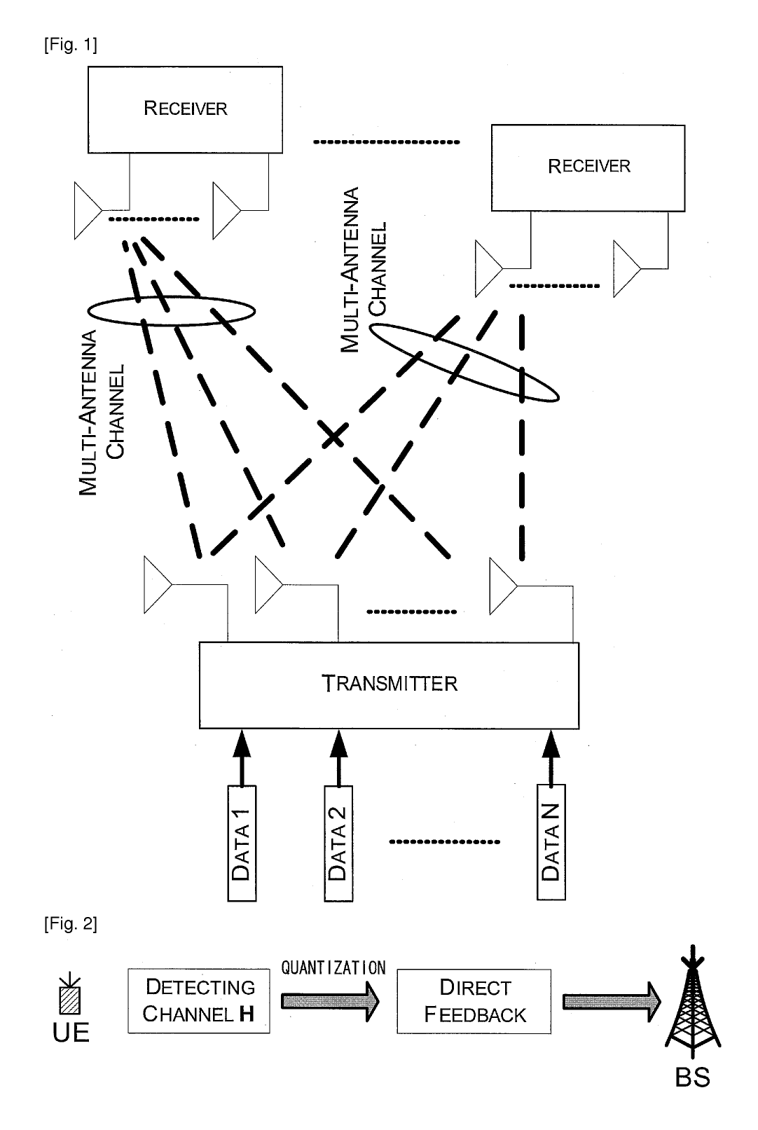

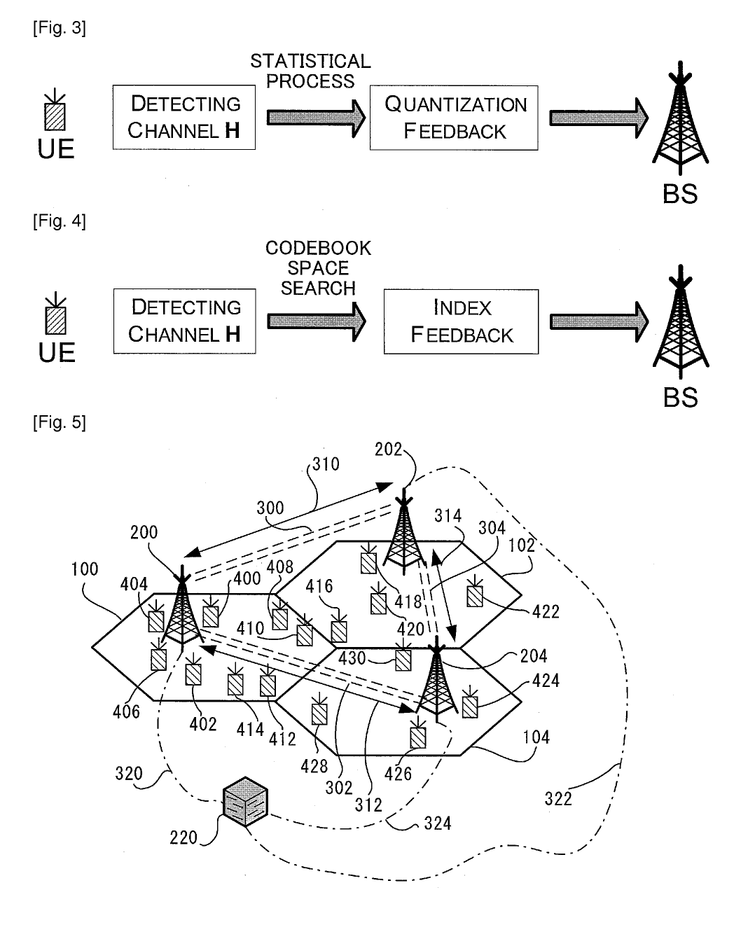

### DESCRIPTION OF EMBODIMENTS

Preferred embodiments of the present invention will be detailed with reference to the drawings. In the following description, details and functions unnecessary to the present invention are omitted so as not to obscure the concept of the invention. For clear and detailed explanation of the implementation steps of the present invention, some specific embodiments applicable to the downlink of the LTE-A cellular communication system are given below. It is to be noted that the present invention is not limited to the application exemplified in the embodiments. Rather, it is applicable to other communication systems, such as the future 5G system.

Also, it is to be noted that, among the terms “serving BS”, “cooperating BS” and “cooperating BS set” used herein, the term “serving BS”, as commonly used by those skilled in the art, refers to a BS which can transmit control signalings directly to a MS. However, for clearly distinguishing between different concepts, the term “cooperating BS” is used in a manner different from that familiar to those skilled in the art. Specifically, although those skilled in the art commonly use the term to refer to all BSs participating in coordination transmission, the term “cooperating BS” used herein refers in particular to other BSs participating in the coordination transmission than the serving BS. The term “cooperating BS set” refers to a set of such “cooperating BSs”. Obviously, there is no “serving BS” included in the cooperating BS set. Moreover, the term “BS” shall not be narrowly interpreted as a single physical entity. Rather, a TP formed by one or more transmission ports can be interpreted as a “BS”, because, from the view of the UE, both the “BS” and the “TP” are logical reference points supplying voice or data service and are not necessary to be distinguished.

FIG. 5 is a schematic diagram of a multi-cell cellular communication system. The cellular system divides a service coverage area into a number of adjacent wireless coverage areas, i.e., cells. In FIG. 5, the entire service area is formed by cells 100, 102 and 104, each being illustratively shown as a hexagon. Base Stations (BSs) 200, 202 and 204 are associated with the cells 100, 102 and 104, respectively. As known to those skilled in the art, each of the BSs 200-204 includes at least a transmitter and a receiver. It is to be noted that a BS, which is generally a serving node in a cell, can also be an independent BS having a function of resource scheduling, a transmitting node belonging to an independent BS, a relay node (which is typically configured for further improving the coverage of a cell), or the like. As illustratively shown in FIG. 5, each of the BSs 200-204 is located in a particular area of the corresponding one of the cells 100-104 and is equipped with an omni-directional antenna. It is to be noted that, however, in a cell arrangement for the cellular communication system, each of the BSs 200-204 can also be equipped with a directional antenna for directionally covering a partial area of the corresponding one of the cells 100-104, which is commonly referred to as a sector. Thus, the diagram of the multi-cell cellular communication system as shown in FIG. 5 is illustrative only and does not imply that the implementation of the present invention in the cellular system relies on the above limitation.

As shown in FIG. 5, the BSs 200, 202 and 204 are connected with each other via X2 interfaces 300, 302 and 304. In an LTE-A system, a three-layer node network architecture including base station, radio network control unit and core network is simplified into a two-layer node architecture in which the function of the radio network control unit is assigned to the base station and a wired interface named “X2” is defined for coordination and communication between base stations.

In FIG. 5, the BSs 200, 202 and 204 are also connected with each other via air interfaces, A1 interfaces, 310, 312 and 314. In a future communication system, it is possible to introduce a concept of relay node. Relay nodes are connected with each other via wireless interfaces and a base station can be considered as a special relay node. Thus, a wireless interface named “A1” can then be used for coordination and communication between base stations.

Additionally, an upper layer entity 220 of the BSs 200, 202 and 204 is also shown in FIG. 5, which can be a gateway or another network entity such as mobility management entity. The upper layer entity 220 is connected to the BSs 200, 202 and 204 via S1 interfaces 320, 322 and 324, respectively. In an LTE-A system, a wired interface named “S1” is defined for coordination and communication between the upper layer entity and the base station.

A number of User Equipments (UEs) 400, 402 . . . 430 are distributed over the cells 100, 102 and 104, as shown in FIG. 5. As known to those skilled in the art, each of the UEs 400-430 includes a transmitter, a receiver and a mobile terminal control unit. Each of the UEs can access the cellular communication system via its serving BS (one of the BSs 200, 202 and 204). It should be understood that while only 16 UEs are illustratively shown in FIG. 5, there may be a large number of UEs in practice. In this sense, the description of the UEs in FIG. 5 is also for illustrative purpose only. Each of the UEs can access the cellular communication network via its serving BS. The BS transmitting control signalings directly to a certain UE is referred to as the serving BS for that UE, while other BSs are referred to non-serving BSs for that UE. The non-serving BSs can function as cooperating BSs which cooperate with the serving BS to provide communication service to the UE.

For explanation of specific embodiments of the present invention, the UE 416 is considered. The UE 416 operates in a multi-BS coordination mode, has BS 202 as its serving BS and has BSs 200 and 204 as its cooperating BSs. It is to be noted that, although focus is placed on the UE 416, this does not imply that the present invention is only applicable to one UE scenario. Rather, the present invention works well for multi-UE scenario. For example, the inventive method can be applied to the UEs 408, 410, 430 and the like as shown in FIG. 5. Of course, although one serving BS and two cooperating BSs are illustrated in the implementation scenario, this does not imply that the application of the present invention relies on such a limitation. In fact, the numbers of serving BSs and cooperating BSs are not limited.

In the following, a CSI feedback method according to the present invention will be described in detail. In description of specific embodiments, the following scenario of multi-BS coordination is assumed:

As an example for illustrative purpose only, the UE 416 operating in a multi-BS coordination mode has BS 202 as its serving BS, and has BSs 200 and 204 as its cooperating BSs (non-serving BSs). For multi-antenna multi-BS coordination transmission to the UE 416, each of the BS 200 and the BS 202 is equipped with 8 transmitting antennae and uses 8 transmission ports, and the BS 204 is equipped with 4 transmitting antennae and uses 4 transmission ports. The UE 416 can be a single-antenna or multi-antenna device. For any other UE (e.g., any of UEs 400-430) operable in the multi-BS coordination mode, there are also serving and cooperating BSs prescribed.

It is to be noted that the transmitting antennae and the transmission ports of a BS are not necessarily in one-to-one correspondence, although typically the number of the BS's transmitting antennae is equal to the number of transmission ports. In practical implementation, a plurality of transmitting antennae of a BS can be mapped to a single transmission port by combining the plurality of transmitting antennae in a weighted manner (see Non Patent Literature 8: 3GPP, R1-092427, “CSI-RS Design for Virtualized LTE Antenna in LTE-A System”, Fujitsu).

Further, it is to be noted that the specific transmission port numbers according to the inconsistent transmission port configurations used in the above scenario are just for illustrative purpose only. The application of the present invention is by no means limited to these numbers. Rather, having regard to embodiments of the present invention, those skilled in the art will appreciate that the present invention is widely applicable to any transmission port configuration.

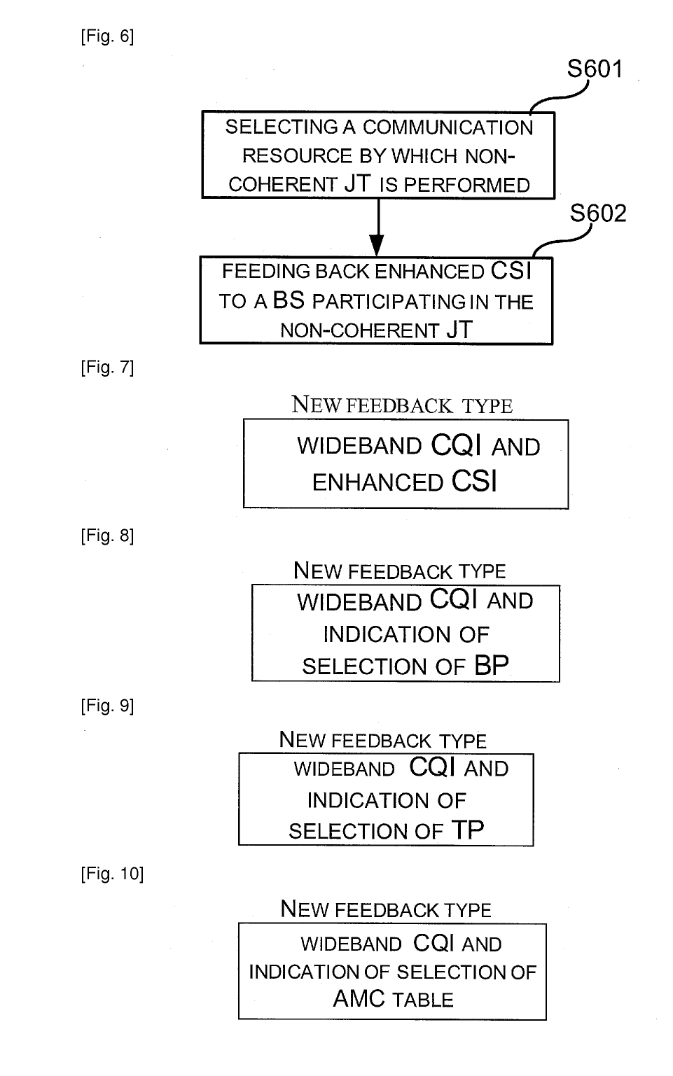

In the following, the flow of the CSI feedback method according to the present invention will be described in detail with reference to FIG. 6. As shown in FIG. 6, the CSI feedback method 600 according to the present invention begins with step S601. In step S601, a UE selects a communication resource by which non-coherent JT is performed. As respectively presented in the following detailed description, the resource may be selected from a set of BPs, a set of TPs or a set of AMC tables. As is proposed, it is also possible to select a group of resource from the union of any two of the above three sets or the union of the above three sets. Further, it should be appreciated that the communication resource is not limited to be selected from the above three kinds of communication resources. In fact, it is conceivable that, in step S601, an appropriate communication resource can be selected from a set of any kind of communication resources influencing the performance of the non-coherent JT.

The criterion for selecting the communication resource is that the selected communication resource can achieve the performance target of the non-coherent JT. In the following detailed description, the performance target of the non-coherent JT is to maximize the system throughput. Those skilled in the art will appreciate that the performance target of the non-coherent JT is not limited thereto, but can be to maximize the system utilization, to guarantee the QoS of user communication, to improve user experience at the cell border, and/or the like.

Subsequently, the method proceeds to step S602, in which the UE feeds back, to a BS participating in the non-coherent JT, an indication of the selected communication resource as enhanced CSI. Accordingly, as presented in the following detailed description, the enhanced CSI may indicate one of the selected BP, the selected TP and the select AMC table; two of the selected BP, the selected TP and the select AMC table; or all of the selected BP, the selected TP and the select AMC table. Also, it should be appreciated that the enhanced CSI is not limited to indicate the above contents. In fact, the contents fed back to the BS participating in the non-coherent JT in step S602 depends on which communication resource(s) is selected in step S601.

In order to be compatible with the existing feedback approaches in the LTE and LTE-A systems as much as possible, a new feedback Mode 1-0 or Mode 2-0 based on the existing feedback Mode 1-0 or Mode 2-0 is introduced to feed back the above-described enhanced CSI. As shown in FIG. 7, by adding the enhanced CSI into Type 4 (wideband CQI) of Mode 1-0 or Mode 2-0, a new feedback type is formed and said new feedback Mode 1-0 or Mode 2-0 is formed. The technical principle behind such a design is that: the non-coherent JT typically achieves a good performance on only a small number of resources (in terms of time, frequency, space, TP or the like); with the enhanced CSI added into Type 4 whose spare payload is relative large, it is possible for the scheduler of the BS to better grasp on which resource(s) the non-coherent JT has a good performance.

As described above, the enhanced CSI may be an indication of selection of a BP, an indication of selection of a TP or an indication of selection of an AMC table, or any combination thereof. In the following, it will be illustrated in detail how to feed back the enhanced CSI by adding the indication of the selected resource into Type 4 (wideband CQI), for respective cases where the enhanced CSI is an indication of selection of a BP, an indication of selection of a TP or an indication of an AMC table.

### (Wideband CQI and Indication of Selection of BP)

### Example 1

Supposing for UE 416 the non-coherent JT achieves a high system throughput at the second BP, the UE 416 may feed back the index #2 of the second BP (typically represented by 1-3 bits) to the serving BS before or after the wideband CQI through concatenated coding, joint coding or the like, when carrying out the feedback of Type 4. As a result, the scheduler of the BS can more accurately grasp on which resource(s) the non-coherent JT has a good performance. The new feedback type thus formed is illustrated as FIG. 8.

### Wideband CQI and Indication of Selection of TP

### Example 2

Supposing for UE 416 the non-coherent JT achieves a high system throughput with a specific TP, the UE 416 may feed back the indication of selection of the TP (typically represented by 1-3 bits) to the serving BS before or after the wideband CQI through concatenated coding, joint coding or the like, when carrying out the feedback of Type 4. As a result, the scheduler of the BS can more accurately grasp on which resource(s) the non-coherent JT has a good performance. The new feedback type thus formed is illustrated as FIG. 9.

For the above feedback, the UE usually needs to first acquire a set of TPs participating in the multi-antenna multi-BS coordination from the serving BS. As a non-limited implementation of this step, the UE (e.g., UE 416) may periodically report to the serving BS (e.g., serving BS 202) path loss information of paths from the UE to its adjacent BSs. Accordingly, the serving BS can estimate the geographic location of the UE from the report, determine the set of TPs participating in the multi-antenna multi-BS coordination based on the estimated geographic location, and semi-statically configure the set of TPs for the UE via upper layer signalings, such as Radio Resource Control (RRC) signalings, or Media Access Control (MAC) layer signalings. Typically, the UE can be simply informed of the RS patterns corresponding to the TPs. In the following, 7 non-limited examples of the TP set will be given for cases wherein the TP set includes 2 to 8 TPs, respectively.

### Example 2(a)

The TP set which the serving BS 202 configures for the UE 416 includes 2 TPs, so that the UE 416 can use 1 bit to feed back the result of choosing one from two opinions. The 2 TPs may include: 1) a TP composed of a total of 8 ports, including ports 0 to 7 of the BS 202; and 2) a TP composed of a total of 8 ports, including ports 0 to 3 of the BS 202, ports 0 and 1 of the BS 200, and ports 2 and 3 of the BS 204.

### Example 2(b)

The TP set which the serving BS 202 configures for the UE 416 includes 3 TPs, so that the UE 416 can use 2 bit to feed back the result of choosing one from three opinions. The 3 TPs may include: 1) a TP composed of a total of 8 ports, including ports 0 to 7 of the BS 202; 2) a TP composed of a total of 8 ports, including ports 0 to 3 of the BS 202, ports 0 and 1 of the BS 200, and ports 2 and 3 of the BS 204; and 3) a TP composed of a total of 8 ports, including ports 0 to 3 of the BS 202, ports 3 and 4 of the BS 200, and ports 0 and 1 of the BS 204.

### Example 2(c)

The TP set which the serving BS 202 configures for the UE 416 includes 4 TPs, so that the UE 416 can use 2 bit to feed back the result of choosing one from four opinions. The 4 TPs may include: 1) a TP composed of a total of 8 ports, including ports 0 to 7 of the BS 202; 2) a TP composed of a total of 8 ports, including ports 0 to 3 of the BS 202, ports 0 and 1 of the BS 200, and ports 2 and 3 of the BS 204; 3) a TP composed of a total of 8 ports, including ports 0 to 3 of the BS 202, ports 3 and 4 of the BS 200, and ports 0 and 1 of the BS 204; and 4) a TP composed of a total of 4 ports, including ports 0 to 3 of the BS 204. It is to be noted that, if the UE chooses the fourth TP, the UE chooses the entire BS 204 equivalently. That is, the DPS transmission approach is implemented. Herein, such a TP corresponding to the DPS transmission may be involved in all illustrative configurations of the set of TPs participating in the multi-antenna multi-BS coordination.

### Example 2(d)

The TP set which the serving BS 202 configures for the UE 416 includes 5 TPs, so that the UE 416 can use 3 bit to feed back the result of choosing one from five opinions. The 5 TPs may include: 1) a TP composed of a total of 8 ports, including ports 0 to 7 of the BS 202; 2) a TP composed of a total of 8 ports, including ports 0 to 3 of the BS 202, ports 0 and 1 of the BS 200, and ports 2 and 3 of the BS 204; 3) a TP composed of a total of 8 ports, including ports 0 to 3 of the BS 202, ports 3 and 4 of the BS 200, and ports 0 and 1 of the BS 204; 4) a TP composed of a total of 4 ports, including ports 0 to 3 of the BS 204; and 5) a TP composed of a total of 4 ports, including ports 4 to 7 of the BS 200. Note that, in practical implementation, it is possible for the number of ports of the fourth and fifth TPs to be different from that of the first three TPs, because different TPs have configurations independent of each other. Herein, such TPs having different numbers of ports may be involved in all illustrative configurations of the set of APs participating in the multi-antenna multi-BS coordination.

### Example 2(e)

The TP set which the serving BS 202 configures for the UE 416 includes 6 TPs, so that the UE 416 can use 3 bit to feed back the result of choosing one from six opinions. The 6 TPs may include: 1) a TP composed of a total of 8 ports, including ports 0 to 7 of the BS 202; 2) a TP composed of a total of 8 ports, including ports 0 to 3 of the BS 202, ports 0 and 1 of the BS 200, and ports 2 and 3 of the BS 204; 3) a TP composed of a total of 8 ports, including ports 0 to 3 of the BS 202, ports 3 and 4 of the BS 200, and ports 0 and 1 of the BS 204; 4) a TP composed of a total of 4 ports, including ports 0 to 3 of the BS 204; 5) a TP composed of a total of 4 ports, including ports 4 to 7 of the BS 200; and 6) a TP composed of a total of 6 ports, including ports 0 to 3 of the BS 204, and ports 7 and 8 of the BS 200. It is to be noted that, the sixth TP is composed of all ports of the BS 204 as well as part (or all) of the ports of another BS. Herein, such a TP may be involved in all illustrative configurations of the set of APs participating in the multi-antenna multi-BS coordination.

### Example 2(f)

The TP set which the serving BS 202 configures for the UE 416 includes 7 TPs, so that the UE 416 can use 3 bit to feed back the result of choosing one from seven opinions. The 7 TPs may include: 1) a TP composed of a total of 8 ports, including ports 0 to 7 of the BS 202; 2) a TP composed of a total of 8 ports, including ports 0 to 3 of the BS 202, ports 0 and 1 of the BS 200, and ports 2 and 3 of the BS 204; 3) a TP composed of a total of 8 ports, including ports 0 to 3 of the BS 202, ports 3 and 4 of the BS 200, and ports 0 and 1 of the BS 204; 4) a TP composed of a total of 4 ports, including ports 0 to 3 of the BS 204; 5) a TP composed of a total of 4 ports, including ports 4 to 7 of the BS 200; 6) a TP composed of a total of 6 ports, including ports 0 to 3 of the BS 204, and ports 7 and 8 of the BS 200; and 7) a TP composed of a total of 8 ports, including ports 0 to 7 of the BS 200.

### Example 2(g)

The TP set which the serving BS 202 configures for the UE 416 includes 8 TPs, so that the UE 416 can use 3 bit to feed back the result of choosing one from eight opinions. The 8 TPs may include: 1) a TP composed of a total of 8 ports, including ports 0 to 7 of the BS 202; 2) a TP composed of a total of 8 ports, including ports 0 to 3 of the BS 202, ports 0 and 1 of the BS 200, and ports 2 and 3 of the BS 204; 3) a TP composed of a total of 8 ports, including ports 0 to 3 of the BS 202, ports 3 and 4 of the BS 200, and ports 0 and 1 of the BS 204; 4) a TP composed of a total of 4 ports, including ports 0 to 3 of the BS 204; 5) a TP composed of a total of 4 ports, including ports 4 to 7 of the BS 200; 6) a TP composed of a total of 6 ports, including ports 0 to 3 of the BS 204, and ports 7 and 8 of the BS 200; 7) a TP composed of a total of 8 ports, including ports 0 to 7 of the BS 200; and 8) a TP composed of a total of ports 3 and 4 of the BS 200, ports 0 to 3 of the BS 202, and ports 0 and 1 of the BS 204. Note that, in practical implementation, it is possible for the eighth TP and the third TP to have the same set of 8 ports ordered differently, because TPs with different port orders shall be regarded as different TPs.

### Wideband CQI and Indication of Selection of AMC Table

### Example 3

Supposing for UE 416 the non-coherent JT achieves a very high system throughput, the UE 416 may feed back the indication of selection of an AMC table (typically represented by 1-3 bits) to the serving BS before or after the wideband CQI through concatenated coding, joint coding or the like, when carrying out the feedback of Type 4. As a result, the scheduler of the BS can accurately grasp on which resource(s) the non-coherent JT can achieve an excellent performance. The new feedback type thus formed is illustrated as FIG. 10.

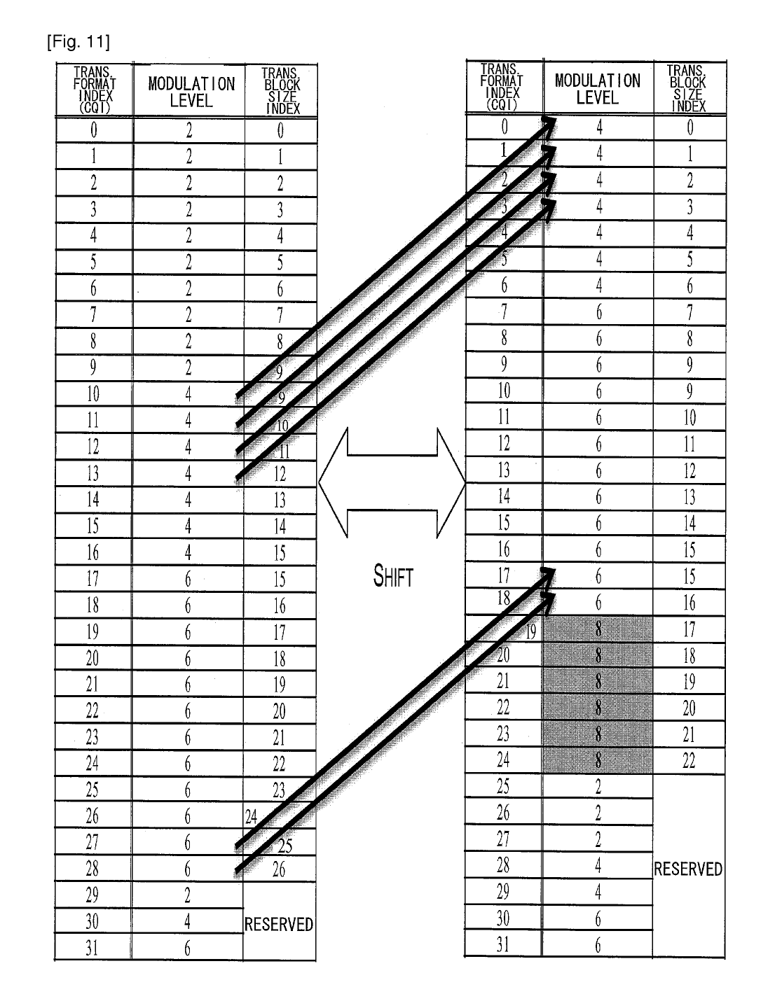

Said AMC table is a mapping table reflecting the mapping relationship between Signal to Interference and Noise Ratio (SINR) and CQI. According to the modulation and coding table, the UE maps a modulation and coding level capable of reliable transmission (a packet error rate of 0.1 is generally considered as a reliable transmission) corresponding to an SINR to a CQI index which is a positive integer (that is, the UE obtains a quantized CQI). When the non-coherent JT is adopted, there may be a plurality of different versions of the modulation and coding table applied for different performances of the non-coherent JT. For example, the plurality of different versions of the modulation and coding table can be obtained by shifting a reference modulation and coding table, as shown in FIG. 11. In FIG. 11, the table on the left side is a modulation and coding table used in the current LTE system, in which the transmission format index refers to the modulation and coding index, i.e., CQI. By shifting the table upwards as a whole, another version of modulation and coding table can be obtained, as shown on the right side of FIG. 11. It is to be noted that, in the table on the right side of FIG. 11, the 19-th to the 24-th rows each having a modulation level of 8 (corresponding to 256 QAM modulation) do not exist in the table on the left side of FIG. 11. This is because that the modulation and coding table is shifted upwards as a whole, resulting in an empty portion in the lower part of the table which needs to be populated with higher level modulation and coding schemes. Of course, the modulation and coding table can be shifted downwards as a whole, resulting in an empty portion in the upper part of the table which needs to be populated with lower level modulation and coding schemes.

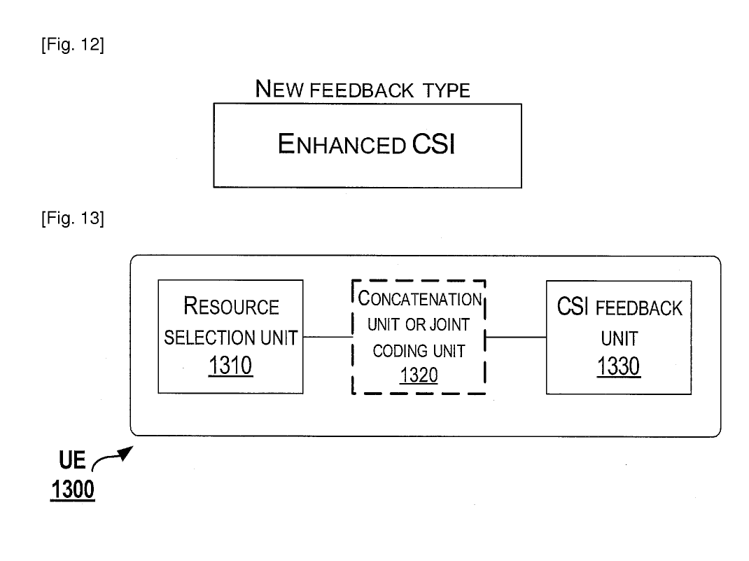

One approach for forming a new feedback Mode 1-0 or Mode 2-0 based on the existing feedback Mode 1-0 or Mode 2-0 has been described above. It is to be noted that the wideband CQI therein has a limited effect for the non-coherent JT. Therefore, as another approach for forming a new feedback Mode 1-0 or Mode 2-0, the wideband CQI may be deleted from Type 4 (wideband CQI) of Mode 1-0 or Mode 2-0 and the enhanced CSI may be added therein, so that a new feedback type is formed as shown in FIG. 12 and a corresponding new feedback Mode 1-0 or Mode 2-0 is formed.

Also, it is to be noted that RI may be unnecessary for the non-coherent JT. This is true when a serving TP has an RI, a cooperating TP does not have an independent RI but simply uses the same RI as the serving TP, and therefore the RI for the non-coherent JT is the same as the RI of the serving TP (see Non Patent Literature 9: R1-114258, Ericsson, “CSI Feedback for DL CoMP” proposed at TSG-RAN WG1 meeting #67). In such a case, it is possible to delete Type 3 (RI) from Mode 1-0 or Mode 2-0 to form a corresponding new Mode 1-0 or Mode 2-0.

Further, it should be noted that, in Type 1 of the existing Mode 2-0, only one preferred sub-band location in a BP and the CQI of the first codeword on the sub-band are fed back. In order to support multi-stream multi-codeword non-coherent JT, a corresponding new Mode 2-0 has to be formed to feed back one preferred sub-band location in the BP and CQIs for individual codewords on the sub-band.

Here, a UE 1300 enabling the implementation of the above CSI feedback methods is also provided. FIG. 13 is a schematic block diagram of the UE 1300 according to the present invention.

As shown in FIG. 13, the UE 1300 according to the present invention comprises: a resource selection unit 1310 configured to select a communication resource by which non-coherent JT is performed, wherein the non-coherent JT achieves a performance target by using the selected communication resource; and a CSI feedback unit 1330 configured to feed back, to a BS participating in the non-coherent JT, an indication of the selected communication resource as enhanced CSI.

Preferably, in an LTE or an LTE-A system, a Mode 1-0 or Mode 2-0 is changed to allow feedback of the enhanced CSI, and the CSI feedback unit feeds back the CSI according to the changed Mode 1-0 or Mode 2-0.

Further, if a feedback Type 4 of a Mode 1-0 or Mode 2-0 is replaced with a feedback type for feeding back a wideband CQI and the enhanced CSI so that a corresponding new Mode 1-0 or Mode 2-0 is formed, the UE may further comprise a concatenation unit 1320 configured to concatenate the enhanced CSI and the wideband CQI, and the CSI feedback unit feeds back the concatenated wideband CQI and enhanced CSI according to the new Mode 1-0 or Mode 2-0. Alternatively, if a feedback Type 4 of a Mode 1-0 or Mode 2-0 is replaced with a feedback type for feeding back a wideband CQI and the enhanced CSI so that a corresponding new Mode 1-0 or Mode 2-0 is formed, the UE may further comprise a joint coding unit 1320 configured to jointly code the enhanced CSI and the wideband CQI, and the CSI feedback unit feeds back the jointly coded wideband CQI and enhanced CSI according to the new Mode 1-0 or Mode 2-0.

The present invention can also be expressed as follows.

To achieve the above object, according to a first aspect of the present invention, a Channel State Information (CSI) feedback method is provided, which comprises: selecting a communication resource by which non-coherent Joint Transmission (JT) is performed, wherein the non-coherent JT achieves a performance target by using the selected communication resource; and feeding back, to a Base Station (BS) participating in the non-coherent JT, an indication of the selected communication resource as enhanced CSI.

Preferably, the enhanced CSI may be an indication of selection of a Band Part (BP), an indication of selection of a Transmission Point (TP), or an indication of selection of an Adaptive Modulation and Coding (AMC) table. Further, the enhanced CSI may be a combination of at least two of the above indications.

Preferably, in an LTE or an LTE-A system, a feedback Type 4 of a Mode 1-0 or a Mode 2-0 is replaced with a feedback Type for feeding back a wideband CQI and the enhanced CSI, so that a new Mode 1-0 or a new Mode 2-0 is formed. Further, the enhanced CSI and the wideband CQI may be concatenated or jointly coded, and the concatenated or jointly coded wideband CQI and enhanced CSI are fed back according to the new Mode 1-0 or the new Mode 2-0.

Alternatively, in an LTE or an LTE-A system, a feedback Type 4 of a Mode 1-0 or a Mode 2-0 is replaced with a feedback type for feeding back only the enhanced CSI.

Preferably, a feedback Type 3 is removed from the Mode 1-0 or the Mode 2-0.

Preferably, a feedback Type 1 of the Mode 2-0 is replaced with a feedback type for feeding back one preferred sub-band location in a BP and CQIs for individual codewords on the sub-band.

To achieve the object of the present invention, according to a second aspect of the present invention, a User Equipment (UE) is provided, which comprises: a resource selection unit configured to select a communication resource by which non-coherent JT is performed, wherein the non-coherent JT achieves a performance target by using the selected communication resource; and a CSI feedback unit configured to feed back, to a BS participating in the non-coherent JT, an indication of the selected communication resource as enhanced CSI.

Preferably, the enhanced CSI is at least one of an indication of selection of a BP, an indication of selection of a TP and an indication of selection of an AMC table.

Preferably, in an LTE or an LTE-A system, a Mode 1-0 or a Mode 2-0 is changed to allow feedback of the enhanced CSI, and the CSI feedback unit feeds back the CSI according to the changed Mode 1-0 or Mode 2-0.

Preferably, a feedback Type 4 of a Mode 1-0 or a Mode 2-0 is replaced with a feedback type for feeding back a wideband CQI and the enhanced CSI, so that a new Mode 1-0 or a new Mode 2-0 is formed, the UE further comprises a concatenation unit configured to concatenate the enhanced CSI and the wideband CQI, and the CSI feedback unit feeds back the concatenated wideband CQI and enhanced CSI according to the new Mode 1-0 or the new Mode 2-0.

Alternatively, the UE comprises a joint coding unit configured to jointly code the enhanced CSI and the wideband CQI, and the CSI feedback unit feeds back the jointly coded wideband CQI and enhanced CSI according to the new Mode 1-0 or the new Mode 2-0.

It should be noted that the solution of the present invention has been described above by a way of example only. However, the present invention is not limited to the above steps and element structures. It is possible to adjust, add and remove the steps and elements structures depending on actual requirements. Thus, some of the steps and elements are not essential for achieving the general inventive concept of the present invention. Therefore, the features necessary for the present invention is only limited to a minimum requirement for achieving the general inventive concept of the present invention, rather than the above specific examples.

The present invention has been described above with reference to the preferred embodiments thereof. It should be understood that various modifications, alternations and additions can be made by those skilled in the art without departing from the spirits and scope of the present invention. Therefore, the scope of the present invention is not limited to the above particular embodiments but only defined by the claims as attached.

1: A Channel State Information (CSI) feedback method, comprising:
selecting a communication resource by which non-coherent Joint Transmission (JT) is performed, wherein the non-coherent JT achieves a performance target by using the selected communication resource; and
feeding back, to a Base Station (BS) participating in the non-coherent JT, an indication of the selected communication resource as enhanced CSI.

2: The CSI feedback method according to claim 1, wherein the enhanced CSI is an indication of selection of a Band Part (BP).

3: The CSI feedback method according to claim 1, wherein the enhanced CSI is an indication of selection of a Transmission Point (TP).

4: The CSI feedback method according to claim 1, wherein the enhanced CSI is an indication of selection of an Adaptive Modulation and Coding (AMC) table.

5: The CSI feedback method according to claim 1, wherein the enhanced CSI is a combined indication of at least two of an indication of selection of a Band Part (BP), an indication of selection of a Transmission Point (TP) and an indication of selection of an Adaptive Modulation and Coding (AMC) table.

6: The CSI feedback method according to claim 1, wherein
in an LTE or an LTE-A system, a feedback Type 4 of a Mode 1-0 or a Mode 2-0 is replaced with a feedback type for feeding back a wideband CQI and the enhanced CSI, so that a new Mode 1-0 or a new Mode 2-0 is formed.

7: The CSI feedback method according to claim 6, wherein
the enhanced CSI and the wideband CQI are concatenated or jointly coded, and
the concatenated or jointly coded wideband CQI and enhanced CSI are fed back according to the new Mode 1-0 or the new Mode 2-0.

8: The CSI feedback method according to claim 1, wherein
in an LTE or an LTE-A system, a feedback Type 4 of a Mode 1-0 or a Mode 2-0 is replaced with a feedback type for feeding back only the enhanced CSI.

9: The CSI feedback method according to claim 6, wherein a feedback Type 3 is removed from the Mode 1-0 or the Mode 2-0.

10: The CSI feedback method according to claim 6, wherein a feedback Type 1 of the Mode 2-0 is replaced with a feedback type for feeding back one preferred sub-band location in a BP and CQIs for individual codewords on the sub-band.

11: A User Equipment (UE), comprising:
a resource selection unit configured to select a communication resource by which non-coherent Joint Transmission (JT) is performed, wherein the non-coherent JT achieves a performance target by using the selected communication resource; and
a Channel State Information (CSI) feedback unit configured to feed back, to a Base Station (BS) participating in the non-coherent JT, an indication of the selected communication resource as enhanced CSI.

12: The UE according to claim 11, wherein the enhanced CSI is at least one of an indication of selection of a Band Part (BP), an indication of selection of a Transmission Point (TP) and an indication of selection of an Adaptive Modulation and Coding (AMC) table.

13: The UE according to claim 11, wherein
in an LTE or an LTE-A system, a Mode 1-0 or a Mode 2-0 is changed to allow feedback of the enhanced CSI, and
the CSI feedback unit feeds back the CSI according to the changed Mode 1-0 or Mode 2-0.

14: The UE according to claim 13, wherein
a feedback Type 4 of a Mode 1-0 or a Mode 2-0 is replaced with a feedback type for feeding back a wideband CQI and the enhanced CSI, so that a new Mode 1-0 or a new Mode 2-0 is formed,
the UE further comprises a concatenation unit configured to concatenate the enhanced CSI and the wideband CQI, and
the CSI feedback unit feeds back the concatenated wideband CQI and enhanced CSI according to the new Mode 1-0 or the new Mode 2-0.

15: The UE according to claim 13, wherein
a feedback Type 4 of a Mode 1-0 or a Mode 2-0 is replaced with a feedback type for feeding back a wideband CQI and the enhanced CSI, so that a new Mode 1-0 or a new Mode 2-0 is formed,
the UE further comprises a joint coding unit configured to jointly code the enhanced CSI and the wideband CQI, and
the CSI feedback unit feeds back the jointly coded wideband CQI and enhanced CSI according to the new Mode 1-0 or the new Mode 2-0.

16: The CSI feedback method according to claim 8, wherein a feedback Type 3 is removed from the Mode 1-0 or the Mode 2-0.

17: The CSI feedback method according to claim 8, wherein a feedback Type 1 of the Mode 2-0 is replaced with a feedback type for feeding back one preferred sub-band location in a BP and CQIs for individual codewords on the sub-band.
